(19) United States
(12) Patent Application Publication
(10) Pub. No.: US 2023/0221679 A1
(43) Pub. Date: Jul. 13, 2023

(54) ITEM VERIFICATION AND AUTHENTICATION SYSTEM AND METHOD

(71) Applicant: Jiri Perkous, Joondalup (AU)

(72) Inventor: Jiri Perkous, Joondalup (AU)

(73) Assignee: Jiri Perkous, Joondalup (AU)

(21) Appl. No.: 17/571,556

(22) Filed: Jan. 10, 2022

(51) Int. Cl. G03H 1/00; G06V 30/224; G06K 7/14; G06Q 10/08

(52) U.S. Cl. CPC G03H 1/0011; G06K 7/1434; G06Q 10/0833; G06V 30/2247

(57) ABSTRACT

Disclosed are a system and method to verify and authenticate an item. The system includes a memory and a processor. The processor includes a reader module, an optical character recognition (OCR) module, an image recognition module, a camera module, and an item digital passport (IDP) module. The reader module scans and processes a matrix barcode and other barcodes. The optical character recognition (OCR) module scans one or more of a micro size alphanumeric code, a nano size alphanumeric code, and a visible alphanumeric code present on a hologram that is embossed, printed, or lasered on the item and verifies the item by comparing the scanned data with the data corresponding to the item stored in the memory. The optical character recognition module authenticates the item if the scanned data matches with the data corresponding to the item stored in the memory. The optical character recognition module facilitates a user interface to display the comparison data and the authentication data. The image recognition module verifies and authenticates one or more of a micro size image, a nano size image, and a visible holographic image present on the hologram. The camera module analyzes the intricate details of one or more of the hologram features and elements, and a security print design features and elements captured by a camera lens. The camera module measures individual features and elements present in the hologram, and the security print design features and elements with an embedded ruler. The item digital passport (IDP) module captures data pertaining to the movement of the items from a source point to a destination point.

### FIELD OF INVENTION

The present invention relates to a system for product and security document verification, authentication, and tracks and trace, in particular to system and method to seamlessly verify the authenticity of an item over an online or offline network.

### BACKGROUND OF THE INVENTION

The subject matter discussed in the background art should not be assumed to be prior art merely as a result of its mention in the background art. Similarly, a problem mentioned in the background art or associated with the subject matter of the background art should not be assumed to have been previously recognized in the prior art. The subject matter in the background art merely represents different approaches, which in-and-of-themselves may also be inventions.

Typically, hologram stickers are used as a mark of authentication which is virtually impossible to replicate. A well-designed hologram sticker provides the ultimate security for its unique and easy verification of various items such as documents, consumer products, etc. Further, hologram stickers are a cost-effective mechanism to assure the authenticity of the items. Holograms are one of the most utilized and recognized by brands, currency, and security document anti-counterfeiting protection elements. Over the years the complexity of design and security features evolved into a very intricate, sophisticated, and eye-catching product. In many cases, the hologram is also an integral part of the overall design of banknotes, packaging, and even security documents. Today’s origination technologies offer high-security micro and nano elements and other overt and covert high-security features.

A few prior arts are trying to authenticate and verify the holograms to assure the end-user such as U.S. Pat. US9697526B2 issued to Guido Ronald et al. discloses that an item can be authenticated based on a first, second, third, and fourth identifier, wherein the identifiers are incorporated into various parts of product packaging. The first, second, and fourth identifiers can be a QR code, a bar code, a serial number, an RFID tag, or a combination thereof, and the third identifier can be an image type, for example, a type of animal, and image location, for example, a quadrant. The identifiers can be scanned or inputted manually by a user. When the four identifiers are authenticated, the product is deemed to be authentic, whereas when the four identifiers are not authenticated, the product is deemed to be counterfeit. In some implementations, a user can authenticate the items using a smartphone, smartphone app, tablet, tablet app, website, web-based application, and/or the like.

Further. U.S. Pat. Publication US2019138778A1 filed by Bharadia Rahul Gopikisan et al. talks about a system for product authentication that comprises a non-replicable security tag, at least one mobile device, and a server. The security tag comprises a background print layer and a foreground print layer. The foreground print layer includes a tag identifier and a variable image pattern. The mobile device scans the security tag and 5 facilitates a first-level authentication of the tag locally on the mobile device. The server is configured to facilitate a second-level authentication for the tag over a network.

However, none of the existing prior systems and methods provide efficient and cost-effective mechanisms for hologram verification and authentication because these systems require a controlled and forensic environment to verify and authenticate the holograms.

This specification recognizes that there is a need for a portable system and method to seamlessly and cost-effectively authenticate a hologram that is embossed on any product and documents.

The disadvantages and limitations of traditional and conventional approaches will become apparent to the person skilled in the art through a comparison of the described system and method with some aspects of the present disclosure, as put forward in the remainder of the present application and with reference to the drawings.

### SUMMARY OF THE PRESENT INVENTION

According to embodiments illustrated herein, there is provided an item verification and authentication system and method over a network.

An aspect of the present disclosure relates to a system to authenticate an item. The system includes a memory and a processor. The processor includes a reader module, an optical character recognition (OCR) module, an image recognition module, a camera module, and an item digital passport (IDP) module. The reader module is configured to scan and process a visible, micro, and nano size matrix barcode. The optical character recognition (OCR) module is configured to scan one or more of a micro size alphanumeric code, a nano size alphanumeric code, and a visible alphanumeric code present on a hologram that is embossed, lasered, or printed on the item and verifies the item by comparing the scanned data with the data corresponding to the item stored in the memory. The optical character recognition module authenticates the item if the scanned data matches with the data corresponding to the item stored in the memory. The optical character recognition module facilitates a user interface to display the comparison data and the authentication data. The image recognition module is configured to verify and authenticate one or more of a micro size image, a nano size image, and a visible holographic image present on the hologram. The camera module is configured to analyse the intricate details of one or more of the holograms, and a security print design features and elements captured by a camera lens. The camera module measures individual features and elements present in the hologram, and the security print design features and elements with an embedded ruler. The item digital passport (IDP) module is configured to capture data pertaining to the movement of the items from a source point to a destination point.

In an aspect, the processor comprises a gallery module configured to store a plurality of multimedia files (photos and videos) captured by the camera lens in a folder of a software application that is commercialized as holoMAX™.

In an aspect, the processor comprises a log module configured to log into a computing device of a customer.

In an aspect, the processor comprises a setting module configured to facilitate the customer to manage the settings of a communication application.

In an aspect, the matrix barcode comprises a quick response (QR) code and /or other barcodes.

An aspect of the present disclosure relates to a method for authenticating an item. The method includes a step of scanning and processing, by one or more processors, a matrix barcode, and/or any other barcode. The method includes a step of scanning, by the processors, one or more of a micro size alphanumeric code, a nano size alphanumeric code, and a visible alphanumeric code present on a hologram that is embossed, lasered, or printed on the item and verifies the item by comparing the scanned data with the data corresponding to the item stored in the memory. The optical character recognition module authenticates the item if the scanned data matches with the data corresponding to the item stored in the memory. The optical character recognition module facilitates a user interface to display the comparison data and the authentication data. The method includes a step of verifying and authenticating, by the processors, one or more of a micro size image, a nano size image, and a visible holographic image present on the hologram. The method includes a step of analysing, by the processors, the intricate details of one or more of the hologram designs features, and a security print design element captured by a camera lens. The camera module also measures individual features and elements present in the hologram, and the security print design with an embedded ruler. The method includes a step of capturing, by the processors, data pertaining to the movement of the items from a source point to a destination point.

In an aspect, the processors are configured to store a plurality of multimedia files (photos and videos) captured by the camera lens in a folder of a software application that is commercialized as holoMAX™.

In an aspect, the processors are configured to log into a computing device of a customer.

In an aspect, the processors are configured to facilitate the customer to manage the settings of a communication application.

In an aspect, the matrix barcode comprises a quick response (QR) code or other barcodes.

Accordingly, one advantage of the present invention is that it provides a software application that can be executed as a mobile application to verify and authenticate hologram, product, or document originality.

Accordingly, one advantage of the present invention is that the mobile application is compatible with various operating systems such as iOS®, Android®, and Windows®.

Accordingly, one advantage of the present invention is that it does not require an internet connection to authenticate the item.

Accordingly, one advantage of the present invention is that it is customizable to various brands, governments, and various entities.

Accordingly, one advantage of the present invention is that it does not require costly hardware, software, and wires, and batteries.

Accordingly, one advantage of the present invention is that it presents the verification and authentication results in seconds.

Accordingly, one advantage of the present invention is that it provides complete hologram security overt and covert codes recognition and authentication. Overt codes are simply visible by the naked eye, and covert codes are right down to micro and nano-text from the size of 4 microns at 100 nanometres resolution.

Accordingly, one advantage of the present invention is that it facilitates the users to access the product, and document details with just a touch gesture over the user interface of the software application

Accordingly, one advantage of the present invention is that it facilitates various business entities and governments to link the software application to their loyalty program, membership, and customer engagement.

Accordingly, one advantage of the present invention is that it enables various business entities and governments to marketize their or other products and services on the software application.

Accordingly, one advantage of the present invention is that it verifies and authenticates the originality (brand protection) of any item to safeguard the brand interests.

Accordingly, one advantage of the present invention is that it provides end-to-end track and trace facilities, logistics modules, loyalty programs, merchandising, and marketing and provides full-service information of the items.

Accordingly, one advantage of the present invention is that it enables the business entities and governments to add videos, speech, and photos related to their items.

Other features of embodiments of the present disclosure will be apparent from accompanying drawings and from the detailed description that follows.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 illustrates a network implementation of the present system to authenticate an item, in accordance with an embodiment of the present subject matter.

FIG. 2 illustrates the present system to authenticate an item, in accordance with an embodiment of the present subject matter.

FIG. 3 illustrates a welcome user interface of a software application, in accordance with at least one embodiment.

FIG. 4 illustrates an AI OCR icon of the software application, in accordance with at least one embodiment.

FIG. 5 illustrates a perspective view of opening the camera of the computing device by the software application, in accordance with at least one embodiment.

FIG. 6 illustrates a verified user interface of the software application, in accordance with at least one embodiment

FIG. 7 illustrates a “not registered” user interface of the software application, in accordance with at least one embodiment.

FIG. 8 illustrates a product details user interface of the software application, in accordance with at least one embodiment.

FIG. 9 illustrates a user interface of the nutritional values, in accordance with at least one embodiment.

FIG. 10 illustrates a flowchart of the method for authenticating an item, in accordance with at least one embodiment.

### DETAILED DESCRIPTION OF THE PREFERRED EMBODIMENT

Systems and methods are disclosed for verifying and authenticating an item. Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

Although the present disclosure has been described with the purpose of verifying and authenticating an item, it should be appreciated that the same has been done merely to illustrate the invention in an exemplary manner and any other purpose or function for which explained structures or configurations could be used, is covered within the scope of the present disclosure.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium may include a non-transitory medium in which data can be stored, and that does not include carrier waves and/or transitory electronic signals propagating wirelessly or over wired connections. Examples of a non-transitory medium may include but are not limited to, a magnetic disk or tape, optical storage media such as compact disk (CD) or versatile digital disk (DVD), flash memory, memory, or memory devices.

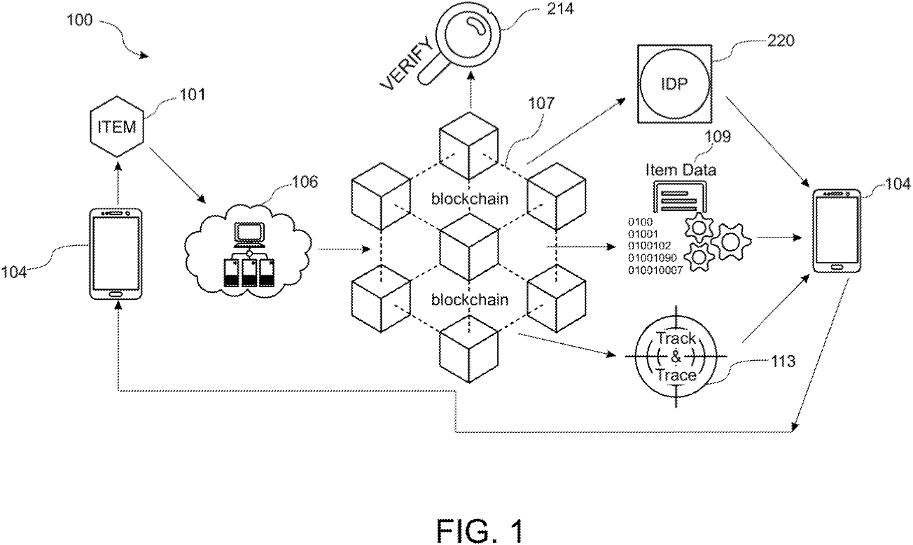

FIG. 1 illustrates a network implementation of the present system 100 to authenticate an item 101, in accordance with an embodiment of the present subject matter. Although the present subject matter is explained considering that the present system 100 is implemented on a server, it may be understood that the present system 100 may also be implemented in a variety of computing systems, such as a laptop computer, a desktop computer, a notebook, a workstation, a mainframe computer, a server, a network server, and the like. It will be understood that the present system 100 may be accessed by multiple users through one or more computing devices, collectively referred to as computing unit 104 hereinafter, or applications residing on the computing unit 104. Examples of the computing unit 104 may include but are not limited to, a portable computer, a personal digital assistant, a handheld or mobile device, smart devices, and a workstation. The computing units 104 are communicatively accessible to the present system 100 through a network 106.

In one implementation, the network 106 may be a wireless network, a wired network, or a combination thereof. The network 106 can be implemented as one of the different types of networks, such as an intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

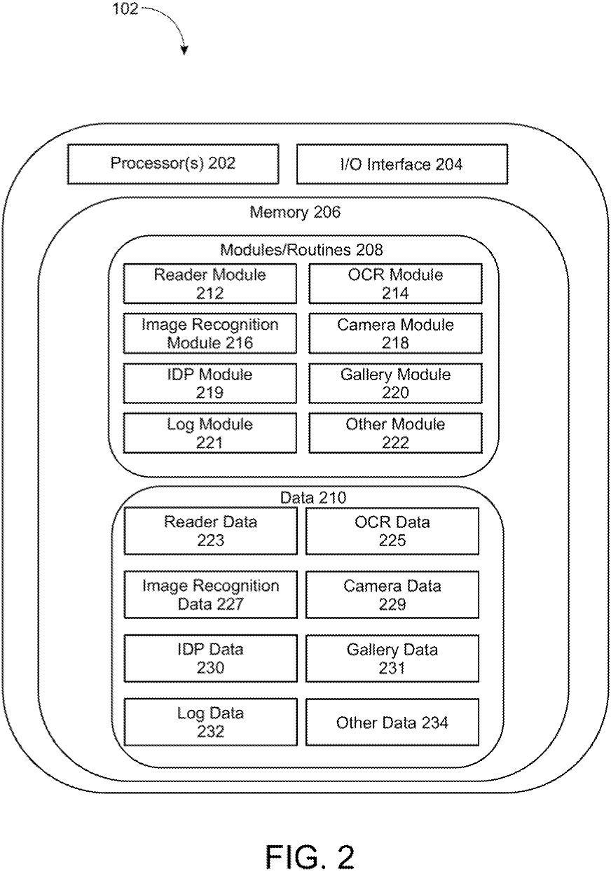

FIG. 2 illustrates the present system 100 to verify and authenticate an item 101, in accordance with an embodiment of the present subject matter. FIG. 2 is explained in conjunction with FIG. 1. The system 100 may include at least one processor 202, an input/output (I/O) interface 204, and a memory 206. The processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206. The I/O interface 204 may include a variety of software and hardware interfaces, for example, a web interface, a graphical user interface, and the like. The I/O interface 204 may allow system 100 to interact with a user directly or through the computing unit 104. Further, the I/O interface 204 may enable the system 100 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a reader module 212, an optical character recognition (OCR) module 214, an image recognition module 216, a camera module 218, an item digital passport (IDP) module 220, and other module 222. The other module 222 may include programs or coded instructions that supplement applications and functions of the system 100.

The data 210, amongst other things, serves as a repository for storing data processed, received, and generated by one or more of the modules 208. The data 210 may also include reader data 223, OCR data 225, image recognition data 227, camera data 229, IDP data 230, gallery data 231, log data 232, and other data 234. The other data 234 may include data generated as a result of the execution of one or more modules in the other module 222.

In one implementation, the reader module 212 is configured to scan and process a matrix barcode or other barcode. In an embodiment, the matrix barcode comprises a quick response (QR) code or any other barcode. In an embodiment, the reader module 212 is a barcode scanner that scans and reads the most common barcodes, and micro and nano-size barcodes embedded into the hologram. The optical character recognition (OCR) module 214 is configured to scan one or more of a micro size alphanumeric code, a nano size alphanumeric code, and a visible alphanumeric code present on a hologram that is embossed, printed, or lasered on item 101 and verifies the item 101 by comparing the scanned data with the data corresponding to the item 101 stored in the memory. Examples of item 101 include but are not limited to edibles, documents, clothes, electrical and electronic components, stationeries, furniture, etc. The optical character recognition module 214 authenticates the item 101 if the scanned data matches with the data corresponding to the item 101 stored in the memory. The optical character recognition module 214 facilitates a user interface to display the comparison data and the authentication data. In an embodiment, the OCR module 214 is artificial intelligence (AI) based OCR integrated within the mobile phone application that verifies and authenticates hidden (micro or nano size) or visible alphanumeric code on the hologram. The user has to simply scan the code and all information about the product or security document will be at the user’s fingertips. The information can be as little as simple text or photo, or as extensive as required.

The image recognition module 216 is configured to verify and authenticate one or more of a micro size image, a nano size image, and a visible holographic image present on the hologram. In an embodiment, the image recognition module 216 verifies and authenticates hidden (micro or nano size) or visible holographic images on the hologram.

The camera module 218 is configured to analyze the intricate details of one or more of the hologram, and a security print design captured by a camera lens. The camera module 218 measures individual features and elements present in the hologram, and the security print design features and elements with an embedded ruler.

The camera module 218 uses the camera to study and interpret the intricate details of hologram or security print design features, with or without the phone’s torch (incorporated within the holoMAX™ application) as a light source. Further, camera module 218 verifies the covert security or design features and elements utilizing the software application’s 400 x magnification ability. The camera module 218 takes photos or videos of the covert and overt security features, design elements, the whole hologram, or security print. Further, the camera module 218 measures individual elements seen through the camera lens with the embedded ruler. Additionally, the camera module 218 is used for standard or microphotography and videos. The camera opens automatically when starting the AI OCR, barcode scanner, or image recognition features.

The item digital passport (IDP) module 220 is configured to capture data 109 (item data) pertaining to the movement of the items from a source point to a destination point. In an embodiment, the item digital passport (IDP) module 220 having a track and trace mechanism 113 to track and trace security documents from print to point of issue. The system includes full document description and document holder (if applicable), print and security features and elements explanation, before and after issuance images, fully customizable. Further, the present system provides an option to connect to government fiscal (tax stamps) and/or other government and corporate departments. The confidential data is protected by a blockchain network 107.

According to an embodiment herein, the IDP module 220 tracks and traces products from manufacturing (farm) to retail point (table) and similar. The IDP module 220 includes information about the manufacturer, suppliers, and wholesalers/distributors, full product description (including images and videos), expiration dates, ingredients, GMO, and sustainability information. Further, the IDP module 220 provides an option to connect to licensing, loyalty and other programs, competitions, and further marketing. The product data will also be protected by the blockchain network 107.

Thus, the IDP module 220 is used to record the movement of parcels or items during transportation. At every processing location, the goods are identified and data relayed to the central processing system. This data is then used to give status/update of the goods movements and up-to-date location from the production line, warehousing, logistics, wholesaler or license holder, a retail outlet to the end customer. It is like a virtual digital passport for every instance of item (s), to log business activities performed on products, their location, and movements throughout the product lifecycle from sourcing, manufacturing, and right to the consumer. According to an embodiment herein, the present system can perform the authentication and verification of the items in both online modes (virtually) and physically in offline mode.

In an embodiment, the processor 202 comprises a gallery module 220 configured to store a plurality of multimedia files (photos and videos) captured by the camera lens in a folder of a software application that is commercialized as holoMAX™. In an embodiment, the gallery module 220 stores photos and videos were taken by the camera in a dedicated holoMAX™ folder and allows the user to send or share videos and photos to other computing devices. In an embodiment, the processor 202 comprises a log module 221 configured to log into a computing device 104 of a customer. In an embodiment, the processor comprises a setting module configured to facilitate the customer to manage the settings of a communication application.

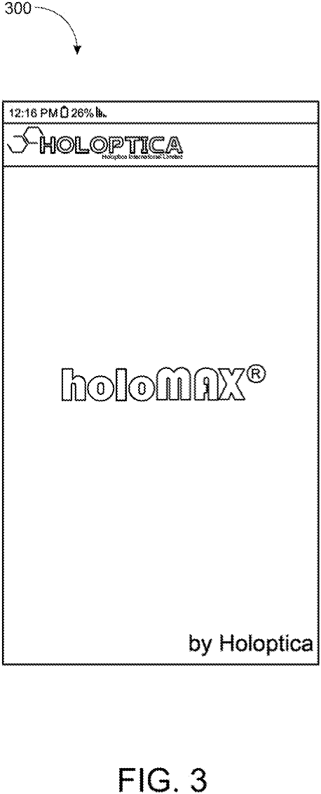

FIG. 3 illustrates a welcome user interface 300 of a software application, in accordance with at least one embodiment. In operation, the user has to install the holoMAX™ application on his/her mobile phone and click on the holoMAX™ icon to access the welcome screen of the software application.

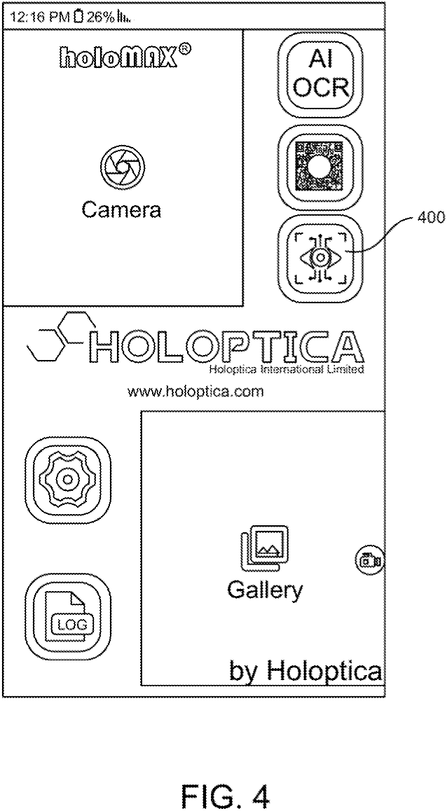

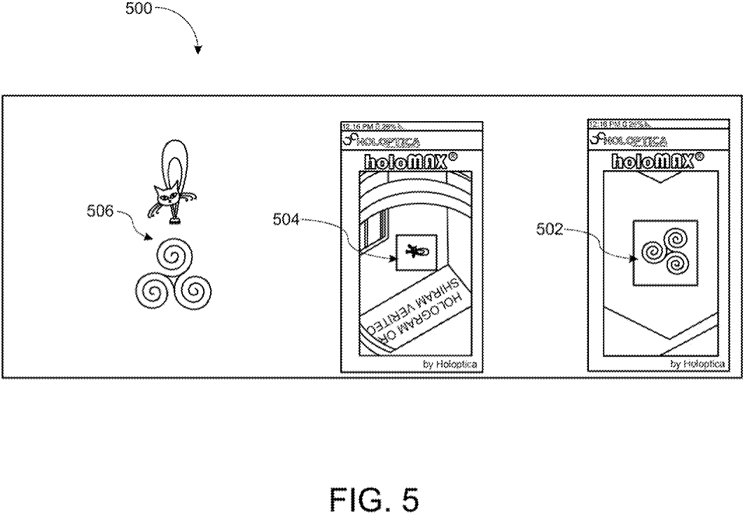

FIG. 4 illustrates an Al OCR icon 400 of the software application, in accordance with at least one embodiment. The user has to click on the AI OCR icon and then the software application opens the camera. The user places the camera over the hologram with an alphanumeric code. FIG. 5 illustrates a perspective view of opening the camera of the computing device by the software application, in accordance with at least one embodiment. The software application with display printed 500 and other text on the screen highlighted by a white frame. In this instance, the printed code is alphanumeric H27JTYFC. The same alphanumeric code is in the white frame. The user has to click on the highlighted text frame window. In an embodiment, other text may also appear as the software application is reading all the texts. The user can choose to verify only the text he/she wants because choosing any other text will return false reading. The software application facilitates the user to scan a patented holographic QR code that is commercialized as holoQR™.

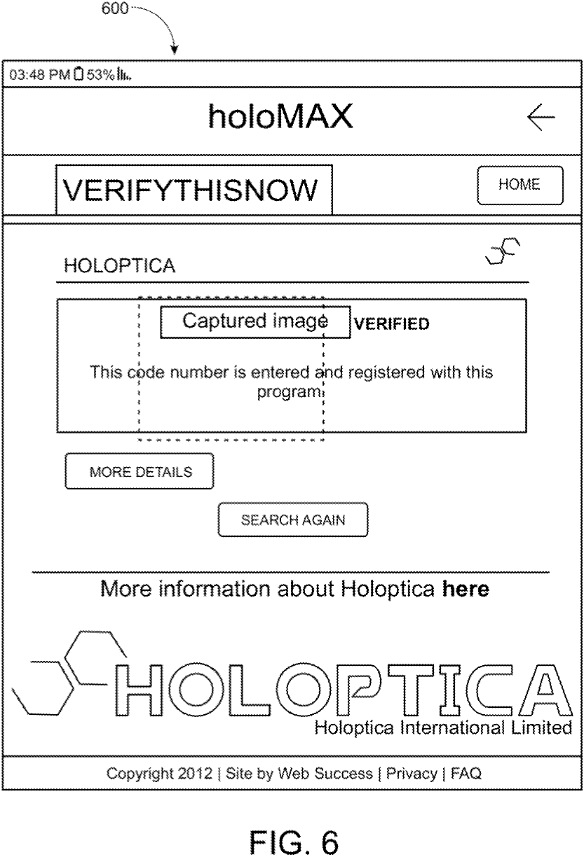

FIG. 6 illustrates a verified user interface 600 of the software application, in accordance with at least one embodiment. If the text or alphanumeric code is registered, the verified window will pop up, with the verified code displayed. The user can verify another product, by simply pressing the “search again” button to return to the camera mode. If the user wants to know more details about the product, he/she has to press the “more details” button.

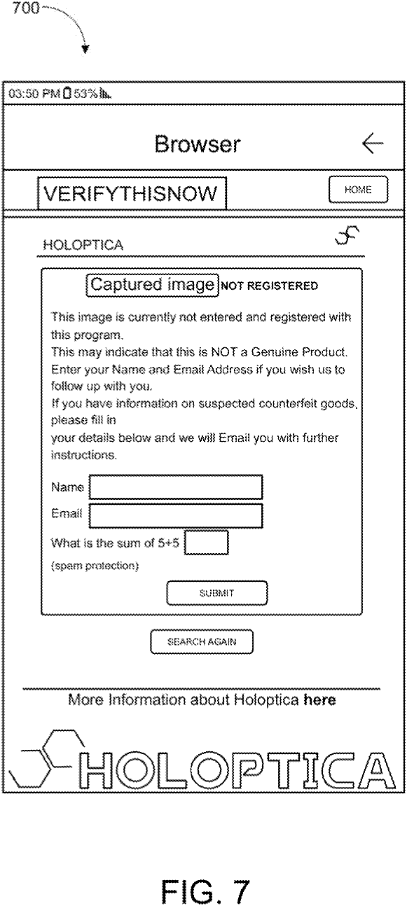

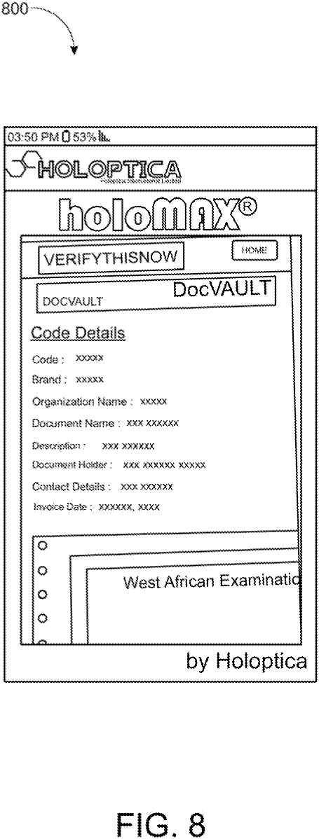

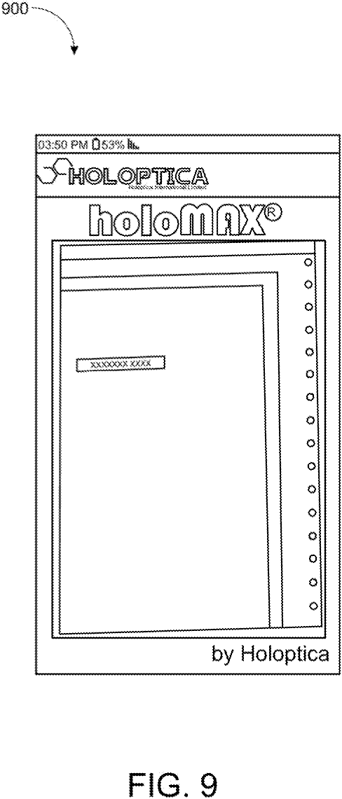

FIG. 7 illustrates a “not registered” user interface 700 of the software application, in accordance with at least one embodiment. If the text or alphanumeric code is not registered “not registered” window will pop up. The user can read the details and if required, follow the instructions. FIG. 8 illustrates a product details user interface 800 of the software application, in accordance with at least one embodiment. If the user presses the “more details” button, an initial product page will pop up. FIG. 9 illustrates a user interface 900 of the nutritional values, in accordance with at least one embodiment. The user scrolls down the screen and sees more information on nutritional values, and clicks on the active links highlighted as blue text. The interface provides various options. In an embodiment, all the information is securely stored online utilizing blockchain or offline within the software application, at customers’ requirement.

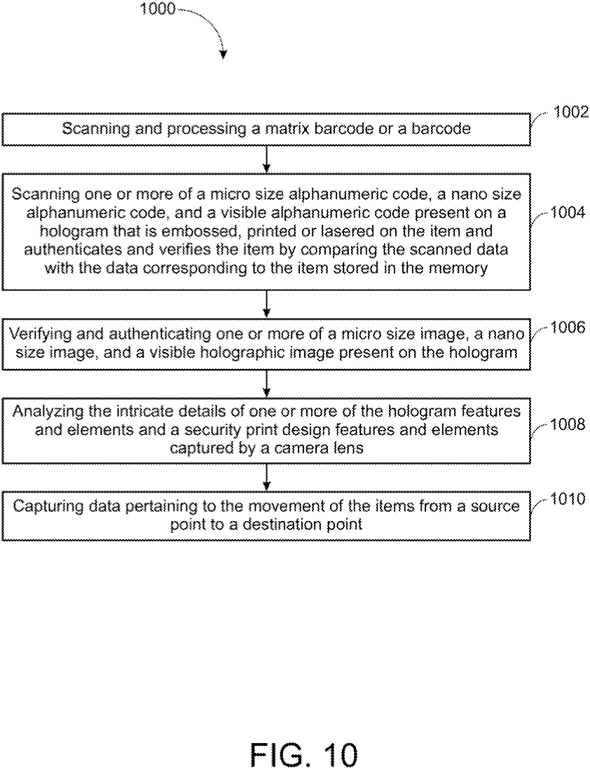

FIG. 10 illustrates a flowchart 1000 of the method for authenticating an item, in accordance with at least one embodiment. The method includes step 1002 of scanning and processing, by one or more processors, a matrix barcode or a barcode. The method includes step 1004 of scanning one or more of a micro size alphanumeric code, a nano size alphanumeric code, and a visible alphanumeric code present on a hologram that is embossed, printed, or lasered on the item and authenticates and verifies the item by comparing the scanned data with the data corresponding to the item stored in the memory. The optical character recognition module authenticates the item if the scanned data matches with the data corresponding to the item stored in the memory. The optical character recognition module facilitates a user interface to display the comparison data and the authentication data. The method includes step 1006 of verifying and authenticating, by the processors, one or more of a micro size image, a nano size image, and a visible holographic image present on the hologram. The method includes step 1008 of analyzing, by the processors, the intricate details of one or more of the hologram features and elements and a security print design features and elements captured by a camera lens. The camera module measures individual elements present in the hologram, and the security print design with an embedded ruler. The method includes step 1010 of capturing, by the processors, data pertaining to the movement of the items from a source point to a destination point. In an embodiment, the processors are configured to store a plurality of multimedia files (photos and videos) captured by the camera lens in a folder of a software application that is commercialized as holoMAX™. In an embodiment, the processors are configured to log into a computing device of a customer. In an embodiment, the processors are configured to facilitate the customer to manage the settings of a communication application. In an embodiment, the matrix barcode comprises a quick response (QR) code.

Thus, the present system and method provide an efficient, simpler, and more elegant framework for authenticating an item. The present system provides a software application that is commercialized as - the holoMAX™ that uses the mobile phone’s camera to read, verify and authenticate the originality of covert (micro or nano size) text or alphanumeric codes embedded into the hologram master. The holoMAX™ does the same with overt (printed or lasered) alphanumeric code on the hologram, packaging, security document, and any other printed matter. The user can simply scan the alphanumeric code and all information about the product or security document is at the user’s fingertips.

While embodiments of the present disclosure have been illustrated and described, it will be clear that the disclosure is not limited to these embodiments only. Numerous modifications, changes, variations, substitutions, and equivalents will be apparent to those skilled in the art, without departing from the scope of the disclosure, as described in the claims.

Claims:

1. A system to authenticate an item, the system comprising:
a memory to store machine-readable instructions; and
a processor coupled to the memory and operable to execute the machine-readable instructions stored in the memory, wherein the processor comprises:
a reader module configured to scan and process one or more of a matrix barcode and other barcodes;
an optical character recognition (OCR) module configured to scan one or more of a micro size alphanumeric code, a nano size alphanumeric code, and a visible alphanumeric code present on a hologram that is embossed, printed, or lasered on the item and verifies the item by comparing the scanned data with the data corresponding to the item stored in the memory, wherein the optical character recognition module authenticates the item if the scanned data matches with the data corresponding to the item stored in the memory, wherein the optical character recognition module facilitates a user interface to display the comparison data and the authentication data;
an image recognition module configured to verify and authenticate one or more of a micro size image, a nano size image, and a visible holographic image present on the hologram;
a camera module configured to analyze the intricate details of one or more of the hologram, and a security print design features and elements captured by a camera lens, wherein the camera module measures individual features and elements present in the hologram, and the security print design features and elements with an embedded ruler; and
an item digital passport (IDP) module configured to capture data pertaining to the movement of the items from a source point to a destination point.

2. The system as claimed in claim 1, wherein the processor comprises a gallery module configured to store a plurality of multimedia files captured by the camera lens in a folder.

3. The system as claimed in claim 1, wherein the processor comprises a log module configured to log into a computing device of a customer.

4. The system as claimed in claim 1, wherein the processor comprises a setting module configured to facilitate the customer to manage settings of a communication application.

5. The system as claimed in claim 1, wherein the matrix barcode comprises a quick response (QR) code or other barcodes.

6. A method for authenticating an item, the method comprising:
scanning and processing, by one or more processors, one or more of a matrix barcode and other barcodes;
scanning, by the processors, one or more of a micro size alphanumeric code, a nano size alphanumeric code, and a visible alphanumeric code present on a hologram that is embossed, printed, or lasered on the item and verifies the item by comparing the scanned data with the data corresponding to the item stored in the memory, wherein the optical character recognition module authenticates the item if the scanned data matches with the data corresponding to the item stored in the memory, wherein the optical character recognition module facilitates a user interface to display the comparison data and the authentication data;
verifying and authenticating, by the processors, one or more of a micro size image, a nano size image, and a visible holographic image present on the hologram;
analyzing, by the processors, the intricate details of one or more of the hologram, and a security print design features and elements captured by a camera lens, wherein the camera module measures individual features and elements present in the hologram, and the security print design features and elements with an embedded ruler; and
capturing, by the processors, data pertaining to the movement of the items from a source point to a destination point.

7. The method as claimed in claim 6, wherein the processors are configured to store a plurality of multimedia files captured by the camera lens in a folder.

8. The method as claimed in claim 6, wherein the processors are configured to log into a computing device of a customer.

9. The method as claimed in claim 6, wherein the processors are configured to facilitate the customer to manage the settings of a communication application.

10. The method as claimed in claim 6, wherein the matrix barcode comprises a quick response (QR) code and other barcodes.
